(19) United States
(12) Patent Application Publication
(10) Pub. No.: US 2025/0063084 A1
(43) Pub. Date: Feb. 20, 2025

(54) METHOD AND APPARATUS FOR CONNECTION MANAGEMENT

(71) Applicant: Telefonaktiebolaget LM Ericsson (publ), Stockholm (SE)

(72) Inventors: Jinqing YAN, Shanghai (CN); Liangliang GUO, Shanghai (CN)

(21) Appl. No.: 18/723,528

(22) PCT Filed: Dec. 30, 2021
(86) PCT No.: PCT/CN2021/143170

§ 371 Date: Jun. 24, 2024

(51) Int. Cl. H04L 67/1008; H04L 43/10; H04L 47/125

(52) U.S. Cl. CPC H04L 67/1008; H04L 43/10; H04L 47/125

(57) ABSTRACT

Embodiments of the present disclosure provide method and apparatus for connection management. A method performed by a monitoring function includes determining that a workload of a network function is out of service. The method further includes sending a message to a connection management function. The message requests the connection management function to delete at least one connection record of at least one connection related to the workload from a connection tracking system.

### TECHNICAL FIELD

The non-limiting and exemplary embodiments of the present disclosure generally relate to the technical field of communications, and specifically to methods and apparatuses for connection management.

### BACKGROUND

This section introduces aspects that may facilitate a better understanding of the disclosure. Accordingly, the statements of this section are to be read in this light and are not to be understood as admissions about what is in the prior art or what is not in the prior art.

Cloud computing is the delivery of computing services—including servers, storage, databases, networking, software, analytics, and intelligence—over a network to offer faster innovation, flexible resources, and economies of scale. A cloud workload is a specific application, service, capability or a specific amount of work that can be run on a cloud resource. Virtual machines, databases, containers, Hadoop nodes and applications may be considered cloud workloads. The benefits of cloud computing will strengthen the promise of wireless network (such as 3rd Generation Partnership Project (3GPP) fifth generation (5G) network) and expand the prospects for several new and enhanced use cases.

For example, Container-as-a-Service (CaaS) such as Kubernetes (K8s) is a cloud service platform that offers container services for user without aware of actual hosts services running on.

FIG. 1 shows an example of traffic handling of cloud native application in a cloud platform according to an embodiment of the present disclosure.

In a cloud platform, it normally includes a controller node (or master node) for cloud management purpose and at least one worker node to run workload function, such as 3GPP 5G network function (NF).

The controller node can monitor at least one worker node based on a heartbeat message in period. If a worker node becomes unreachable, all traffics to that node are lost. CaaS such as K8s may offer a parameter to configure a node monitor timer to a lower value.

The workloads such as a 5G NF can be exposed using Virtual IP (Internet protocol) address (VIP), e.g. K8s service IP address to clients outside the K8s cluster. For example, the traffics from a client first reach an external load balancer (LB). The external LB is aware of a worker node's IP address as a next hop using a routing protocol and can load balance the traffics to the next hop. The traffics are then forwarded to a worker node based on a mechanism such as Equal cost multi-path routing (ECMP) and handled by an internal LB on the worker node. The internal LB can distribute the traffics to a workload for example based on a load balancing rule.

CaaS can setup at least one load balancing rule to an internal LB when deploying workloads. The LB can introduce a connection tracking mechanism to persist an established connection and can perform backend workload selection only once for each connection, which may save clock cycles.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

FIG. 2 shows an example of a load balancer with connection tracking system according to an embodiment of the present disclosure.

At step-1, the connection tracking system may create a connection record when delivering the first packet of a connection to LB rules which will select a workload to consume the packet.

At step-2, with connection tracking, the load balancer only needs to perform workload selection once for a connection. Connection tracking system can bypass the LB rules and forwards the subsequent packets of the connection to previously selected workload directly.

A connection entry or record can be deleted when a corresponding connection is closed or the timer of the connection entry or record is timeout. The timer may be refreshed every time a new packet in the corresponding connection comes to network.

The K8s default iptables-based data plane acts as above. But regardless of which Container Network Interface (CNI) plugin is used, the data plane provides connection time load balancing for new traffics.

There are some problems with the existing cloud platform or system. For example, the configured parameters can impact on system performance with a cascading effect when many worker nodes having many workloads start failing at the same time. It is hard to do optimization only for one or more specified workloads.

In some communication interfaces such as 5GC (5G core network) SMF SBI (Service Based Interface) interface, all HTTP traffics are long-lived connection based. When a worker node becomes unreachable, the path from other worker node's LB/connection tracking system to the worker node becomes black hole to client because the connection(s) is not reset quickly. For example, client can hang up to 15 minutes (under the default Linux kernel setting net.ipv4.tcp_retries2=15, rto_min=200 ms, rto_max=120s) in the worst case until Transmission Control Protocol (TCP) read timeout happens.

The cause of the problem is that long-lived connection in connection tracking system is not deleted or not deleted fast. For example, the CNI plugin in the K8s may delete connections from the connection tracking system after a node is detected as failure but it is not fast enough. Different CNIs have different time setting and some CNIs do not delete the connection entries. The deleting can happen in up to several minutes. Different CNI data planes have different policy to maintain connection(s) in the connection tracking system, which is hard to optimize for some use cases (such as 5GC use case) as this is a global CaaS configuration and it has side effect.

To overcome or mitigate at least one above mentioned problems or other problems, an improved solution for connection management may be desirable.

In a first aspect of the disclosure, there is provided a method performed by a monitoring function. The method comprises determining that a workload of a network function is out of service. The method further comprises sending a message to a connection management function. The message requests the connection management function to delete at least one connection record of at least one connection related to the workload from a connection tracking system.

In an embodiment, the method further comprises receiving a heartbeat message from the workload at a predetermined period. The workload is determined as out of service based on at least one of the monitoring function cannot receive the heartbeat message from the workload within the predetermined period, or a predefined number of heartbeat messages are not received from the workload.

In an embodiment, the workload is deployed on a cloud node.

In an embodiment, the network function comprises a network function of a 3rd Generation Partnership Project (3GPP) fifth generation system.

In an embodiment, the network function of the 3GPP fifth generation system comprises at least one of Session Management Function (SMF), Access and mobility Function (AMF), Authentication Service Function (AUSF), Unified Data Management (UDM), Policy Control Function (PCF), Application Function (AF), Network Exposure Function (NEF), User plane Function (UPF), Network Repository Function (NRF), service communication proxy (SCP), network data analytics function (NWDAF), Network Slice Selection Function (NSSF), Network Slice-Specific Authentication and Authorization Function (NSSAAF), or Network Slice Admission Control Function (NSACF).

In an embodiment, the at least one connection comprises a layer 4 protocol connection.

In an embodiment, the layer 4 protocol connection comprises at least one of a Transmission Control Protocol (TCP) connection, a User Datagram Protocol (UDP) connection, or a Stream Control Transmission Protocol (SCTP) connection.

In an embodiment, the layer 4 protocol connection comprises a long lived layer 4 protocol connection.

In an embodiment, the network function comprises two or more workloads.

In an embodiment, a load balancer is responsible for forwarding initial traffic of a connection from a consumer of the network function to a selected workload of the network function. The connection tracking system is responsible for recording a path of the initial traffic to the selected workload. Subsequent traffic of the connection from the consumer of the network function is forwarded to the selected workload according to the path of the initial traffic.

In an embodiment, a connection record in the connection tracking system comprises at least one of source address, destination address, source port number, destination port number, layer-4 protocol information, or layer-3 protocol information.

In an embodiment, a connection record in the connection tracking system comprises a 5 tuple record or entry.

In a second aspect of the disclosure, there is provided a method performed by a connection management function. The method comprises receiving a message from a monitoring function. The message requests the connection management function to delete at least one connection record of at least one connection related to a workload of a network function from a connection tracking system. The method further comprises deleting the at least one connection record of the at least one connection related to the workload of the network function from the connection tracking system.

In an embodiment, the workload is deployed on a cloud node.

In an embodiment, the network function comprises a network function of a 3rd Generation Partnership Project (3GPP) fifth generation system.

In an embodiment, the network function of the 3GPP fifth generation system comprises at least one of Session Management Function (SMF), Access and mobility Function (AMF), Authentication Service Function (AUSF), Unified Data Management (UDM), Policy Control Function (PCF), Application Function (AF), Network Exposure Function (NEF), User plane Function (UPF), Network Repository Function (NRF), service communication proxy (SCP), network data analytics function (NWDAF), Network Slice Selection Function (NSSF), Network Slice-Specific Authentication and Authorization Function (NSSAAF), or Network Slice Admission Control Function (NSACF).

In an embodiment, the at least one connection comprises a layer 4 protocol connection.

In an embodiment, the layer 4 protocol connection comprises at least one of a Transmission Control Protocol (TCP) connection, a User Datagram Protocol (UDP) connection, or a Stream Control Transmission Protocol (SCTP) connection.

In an embodiment, the layer 4 protocol connection comprises a long lived layer 4 protocol connection.

In an embodiment, the network function comprises two or more workloads.

In an embodiment, a load balancer is responsible for forwarding initial traffic of a connection from a consumer of the network function to a selected workload of the network function. The connection tracking system is responsible for recording a path of the initial traffic to the selected workload. Subsequent traffic of the connection from the consumer of the network function is forwarded to the selected workload according to the path of the initial traffic.

In an embodiment, a connection record in the connection tracking system comprises at least one of source address, destination address, source port number, destination port number, layer-4 protocol information, or layer-3 protocol information.

In an embodiment, a connection record in the connection tracking system comprises a 5 tuple record or entry.

In a third aspect of the disclosure, there is provided a method performed by a workload of a network function. The method comprises sending a heartbeat message to a monitoring function at a predetermined period. The heartbeat message is used for determining whether the workload of the network function is out of service.

In an embodiment, the workload is determined as out of service based on at least one of the monitoring function cannot receive the heartbeat message from the workload within the predetermined period, or a predefined number of heartbeat messages are not received from the workload.

In an embodiment, the workload is deployed on a cloud node.

In an embodiment, the network function comprises a network function of a 3rd Generation Partnership Project (3GPP) fifth generation system.

In an embodiment, the network function of the 3GPP fifth generation system comprises at least one of Session Management Function (SMF), Access and mobility Function (AMF), Authentication Service Function (AUSF), Unified Data Management (UDM), Policy Control Function (PCF), Application Function (AF), Network Exposure Function (NEF), User plane Function (UPF), Network Repository Function (NRF), service communication proxy (SCP), network data analytics function (NWDAF), Network Slice Selection Function (NSSF), Network Slice-Specific Authentication and Authorization Function (NSSAAF), or Network Slice Admission Control Function (NSACF).

In an embodiment, the at least one connection comprises a layer 4 protocol connection.

In an embodiment, the layer 4 protocol connection comprises at least one of a Transmission Control Protocol (TCP) connection, a User Datagram Protocol (UDP) connection, or a Stream Control Transmission Protocol (SCTP) connection.

In an embodiment, the layer 4 protocol connection comprises a long lived layer 4 protocol connection.

In an embodiment, the network function comprises two or more workloads.

In an embodiment, a load balancer is responsible for forwarding initial traffic of a connection from a consumer of the network function to a selected workload of the network function. The connection tracking system is responsible for recording a path of the initial traffic to the selected workload. Subsequent traffic of the connection from the consumer of the network function is forwarded to the selected workload according to the path of the initial traffic.

In an embodiment, a connection record in the connection tracking system comprises at least one of source address, destination address, source port number, destination port number, layer-4 protocol information, or layer-3 protocol information.

In an embodiment, a connection record in the connection tracking system comprises a 5 tuple record or entry.

In a fourth aspect of the disclosure, there is provided a monitoring function. The monitoring function comprises a processor and a memory coupled to the processor. Said memory contains instructions executable by said processor. Said monitoring function is operative to determine that a workload of a network function is out of service. Said monitoring function is further operative to send a message to a connection management function. The message requests the connection management function to delete at least one connection record of at least one connection related to the workload from a connection tracking system.

In a fifth aspect of the disclosure, there is provided a connection management function, comprises a processor and a memory coupled to the processor. Said memory contains instructions executable by said processor. Said connection management function is operative to receive a message from a monitoring function. The message requests the connection management function to delete at least one connection record of at least one connection related to a workload of a network function from a connection tracking system. Said connection management function is further operative to delete the at least one connection record of the at least one connection related to the workload of the network function from the connection tracking system.

In a sixth aspect of the disclosure, there is provided a workload of a network function, comprises a processor and a memory coupled to the processor. Said memory contains instructions executable by said processor. Said workload of the network function is operative to send a heartbeat message to a monitoring function at a predetermined period. The heartbeat message is used for determining whether the workload of the network function is out of service.

In a seventh aspect of the disclosure, there is provided a monitoring function. The monitoring function comprises a determining module configured to determining that a workload of a network function is out of service. The monitoring function further comprises a sending module configured to send a message to a connection management function. The message requests the connection management function to delete at least one connection record of at least one connection related to the workload from a connection tracking system.

In an embodiment, the monitoring function further comprises a receiving module configured to receive a heartbeat message from the workload at a predetermined period. The workload is determined as out of service based on at least one of the monitoring function cannot receive the heartbeat message from the workload within the predetermined period or a predefined number of heartbeat messages are not received from the workload.

In an eighth aspect of the disclosure, there is provided a connection management function. The connection management function comprises a receiving module configured to receive a message from a monitoring function. The message requests the connection management function to delete at least one connection record of at least one connection related to a workload of a network function from a connection tracking system. The connection management function further comprises a deleting module configured to deleting the at least one connection record of the at least one connection related to the workload of the network function from the connection tracking system.

In a ninth aspect of the disclosure, there is provided a workload of a network function. The workload comprises a sending module configured to send a heartbeat message to a monitoring function at a predetermined period. The heartbeat message is used for determining whether the workload of the network function is out of service.

In a tenth aspect of the disclosure, there is provided a computer program product comprising instructions which, when executed on at least one processor, cause the at least one processor to carry out any of the methods according to the first, second and third aspects of the disclosure.

In an eleventh aspect of the disclosure, there is provided a computer-readable storage medium storing instructions which, when executed on at least one processor, cause the at least one processor to carry out any of the methods according to the first, second and third aspects of the disclosure.

Embodiments herein afford many advantages, of which a non-exhaustive list of examples follows. In some embodiments herein, it proposed a server side solution that does not impact on the client behavior or require client changes. For example, the client implementation in the 3GPP standard does not specify monitoring for the HTTP over long live TCP connection. The client behaviors may be different. This is super important in a multiple vendor environment which is a typical deployment scenario for a communication network since it is hard to ask other vendor's clients to change. Some embodiments herein can fast delete hung connections. All related connections can be deleted as soon as a node or workload becomes unreachable. Some embodiments herein can enable cloud agonistic. The proposed solution can offer a fast detect solution without depending on cloud platform and special capabilities of a CNI plugin. Some CNI might offer fast connection deleting in the connection track deleting. If a vendor product prefers it, then the CNI plugin is locked in. Sometimes it is hard to optimize the node failure detection behavior to optimize the connection tracking system fast deletion when the control plane can be owned by a cloud provider such as CaaS provider, HCP (Hyperscale Cloud Platform) provider, Openshift private cloud providers. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example of traffic handling of cloud native application in a cloud platform according to an embodiment of the present disclosure;

FIG. 2 shows an example of a load balancer with connection tracking system according to an embodiment of the present disclosure;

FIG. 3 schematically shows system architecture in a 4G network according to an embodiment of the present disclosure;

FIG. 4 schematically shows a high level architecture in the fifth generation network according to an embodiment of the present disclosure;

FIG. 5 schematically shows an example of 5GC SMF SBI interface over long live TCP connections according to an embodiment of the present disclosure;

FIG. 6 schematically shows an example of cloud native 5G SMF in the K8s container platform according to an embodiment of the present disclosure;

FIG. 7 schematically shows an example of unreachable worker node in K8s container platform according to an embodiment of the present disclosure;

FIG. 8 schematically shows an example of a blackhole connection before reset according to an embodiment of the present disclosure;

FIG. 9 schematically shows an example of cloud infrastructure according to an embodiment of the present disclosure;

FIG. 10 shows a flowchart of a method according to an embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of network function deployment according to an embodiment of the present disclosure;

FIG. 15 shows a flowchart of traffics handling during workload failover according to an embodiment of the present disclosure;

FIG. 16 is a block diagram showing an apparatus suitable for practicing some embodiments of the disclosure;

FIG. 17 is a block diagram showing a monitoring function according to an embodiment of the disclosure;

FIG. 18 is a block diagram showing a connection management function according to an embodiment of the disclosure; and

FIG. 19 is a block diagram showing a workload of a network function according to an embodiment of the disclosure.

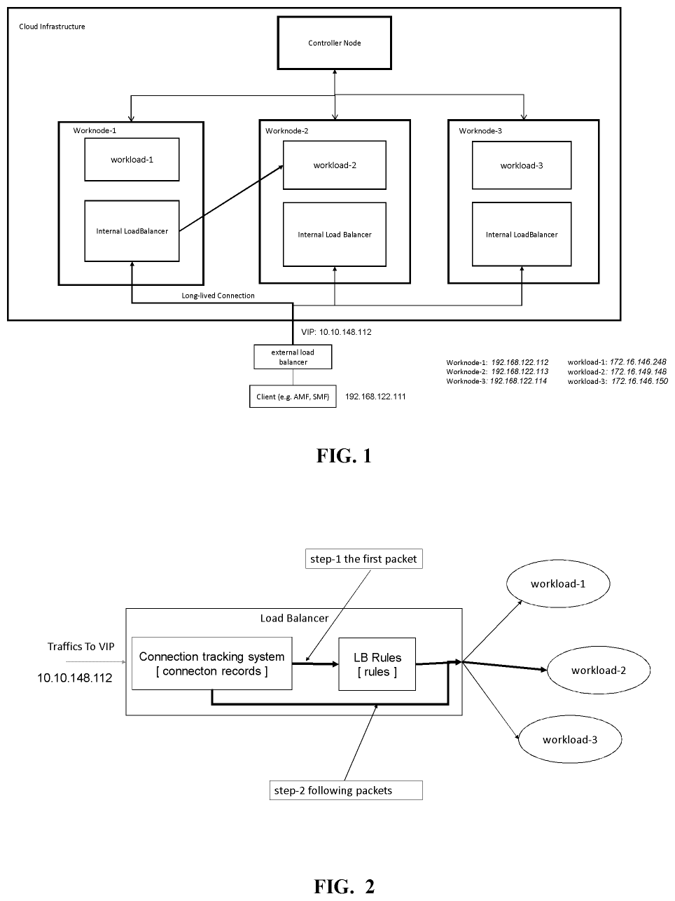

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term monitoring function, connection management function, network function refers to any suitable function which can be implemented in a network node (physical or virtual) of a communication network. For example, the network node can be implemented either as a network element on a dedicated hardware, as a software instance running on a dedicated hardware, or as a virtualized function instantiated on an appropriate platform, e.g. on a cloud infrastructure.

Virtualizing means creating virtual versions of apparatuses or devices which may include virtualizing hardware platforms, storage devices and networking resources. As used herein, virtualization can be applied to a network node and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments hosted by one or more of hardware nodes. Further, in embodiments in which the virtual node is not a radio access node or does not require radio connectivity (e.g., a core network node), then the provider edge node or PE may be entirely virtualized.

The functions may be implemented by one or more applications (which may alternatively be called software instances, virtual appliances, network functions, virtual nodes, virtual network functions, etc.) operative to implement some of the features, functions, and/or benefits of some of the embodiments disclosed herein. Applications are run in virtualization environment which provides hardware comprising processing circuitry and memory. Memory contains instructions executable by processing circuitry whereby application is operative to provide one or more of the features, benefits, and/or functions disclosed herein.

Virtualization environment, comprises general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media-having stored therein software and/or instructions executable by processing circuitry. Software may include any type of software including software for instantiating one or more virtualization layers (also referred to as hypervisors), software to execute virtual machines as well as software allowing it to execute functions, features and/or benefits described in relation with some embodiments described herein.

Virtual machines, comprise virtual processing, virtual memory, virtual networking or interface and virtual storage, and may be run by a corresponding virtualization layer or hypervisor. Different embodiments of the instance of virtual appliance may be implemented on one or more of virtual machines, and the implementations may be made in different ways.

During operation, processing circuitry executes software to instantiate the hypervisor or virtualization layer, which may sometimes be referred to as a virtual machine monitor (VMM). Virtualization layer may present a virtual operating platform that appears like networking hardware to virtual machine.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies such as wireless sensor network may equally be utilized as long as exemplary embodiments described herein are applicable.

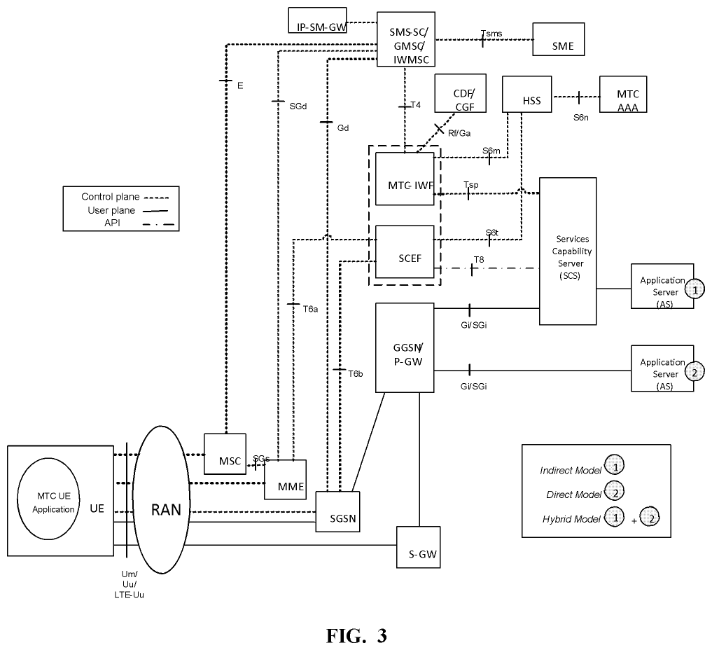

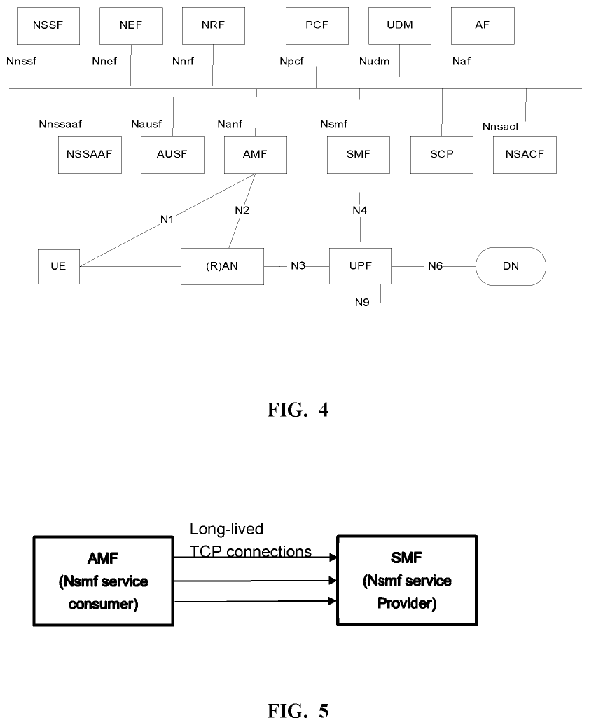

FIGS. 3-4 show some system architectures in which the embodiments of the present disclosure can be implemented. For simplicity, the system architectures of FIGS. 3-4 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 3 schematically shows system architecture in a 4G network according to an embodiment of the present disclosure, which is the same as FIG. 4.2-1a of 3GPP TS 23.682 V17.0.0, the disclosure of which is incorporated by reference herein in its entirety. The system architecture of FIG. 3 may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 3 may be same as the corresponding network elements and interfaces as described in 3GPP TS 23.682 V17.0.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 3, the exemplary system architecture also contains various reference points.
Tsms: Reference point used by an entity outside the 3GPP network to communicate with UEs used for MTC via SMS (Short Message Service).
Tsp: Reference point used by a SCS to communicate with the MTC-IWF related control plane signalling.
T4: Reference point used between MTC-IWF and the SMS-SC in the HPLMN.
T6a: Reference point used between SCEF and serving MME.
T6b: Reference point used between SCEF and serving SGSN.
T8: Reference point used between the SCEF and the SCS/AS.
S6m: Reference point used by MTC-IWF to interrogate HSS/HLR (Home Location Register).
Son: Reference point used by MTC-AAA to interrogate HSS/HLR.
S6t: Reference point used between SCEF and HSS.
SGs: Reference point used between MSC and MME.
Gi/SGi: Reference point used between GGSN/P-GW and application server and between GGSN/P-GW and SCS.
Rf/Ga: Reference point used between MTC-IWF and CDF/CGF.
Gd: Reference point used between SMS-SC/GMSC/IWMSC and SGSN.
SGd: Reference point used between SMS-SC/GMSC/IWMSC and MME.
E: Reference point used between SMS-SC/GMSC/IWMSC and MSC.

FIG. 4 schematically shows a high level architecture in the fifth generation network according to an embodiment of the present disclosure. For example, the fifth generation network may be 5GS. The architecture of FIG. 4 is same as FIG. 4.2.3-1 as described in 3GPP TS 23.501 V17.0.0, the disclosure of which is incorporated by reference herein in its entirety. The system architecture of FIG. 4 may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 4. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 4, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 4 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 4 may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.0.0.

FIG. 5 schematically shows an example of 5GC SMI SBI interface over long live TCP connections according to an embodiment of the present disclosure. 5GC is the 5G core network where a service-based architecture is used with functions defined as network function. Among NFs, a Service Based Interface (SBI) is defined. The SBI interface is HTTP2 based protocol where Hypertext Transfer Protocol (HTTP) over a long live TCP connection is used for communications between two NFs. The interfaces as shown in FIG. 4 are SBI interfaces. For example, an AMF which is used as an SMF Nsmf SBI interface consumer may spawn multiple TCP connections to the SMF during startup and use these connections for sending 5GC SBI signaling for 5G use cases.

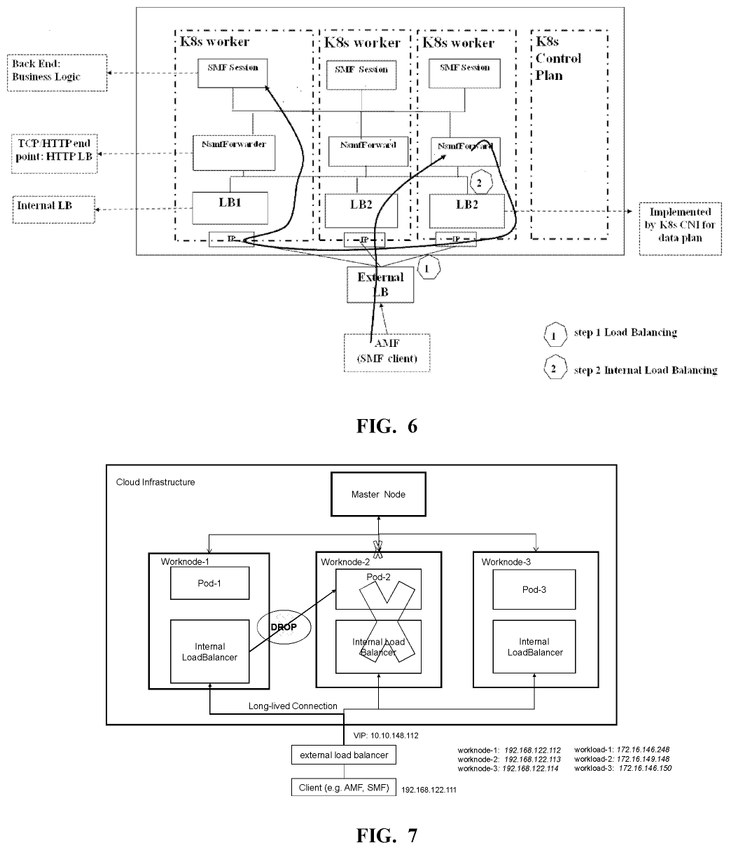

FIG. 6 schematically shows an example of cloud native 5G SMF in the K8s container platform according to an embodiment of the present disclosure.

5GC implementation may be coupled with cloud native technology. For example, some 5GC vendors may build its 5GC product in cloud native computing context. A NF may comprise a lot of micro service entities spreading across host/VMs (virtual machines) in a container platform. The K8s is an container platform where the cloud native applications are running.

A typical cloud native NF can be divided into frontend and backend category. The frontend is responsible for terminating the L4 (layer 4) TCP/User Datagram Protocol (UDP)/Stream Control Transmission Protocol (SCTP) or L7 (layer 7) such HTTP traffic (in the SBI case) and load balancing the traffics to backends where the business logic is executed. The SMF NF may have Nsmf forwarders (Pod or containers) distributed on 3 hosts for receiving incoming HTTP traffics and forwarding the HTTP traffic towards backend SMF Session workloads (Pods).

The TCP SYN packet under a HTTP connection request from AMF as the client first reaches the external LB. The external LB is aware of the worker node IP address as the next hop using the routing protocol and load balances the TCP SYN packet to the next hop. The TCP SYN packet is then forwarded to a worker node based on a mechanism such as ECMP. This is the Step-1 load balancing which is responsible for distributing the traffics to worker nodes.

The internal LB on the worker node within the K8s cluster then selects a Nsmf Forwarder as the next HTTP end point for receiving the traffics. This is the step-2 internal load balancing.

The Nsmf Forwarder terminates the TCP request and then selects a SMF session entity to forward the request using internal protocol.

After this, the long-lived TCP connection is established following the same packet path as the TCP SYN request. All the messages using this HTTP/TCP connection follow the same path after the TCP is established. The traffic path will be tracked in the stateful conntrack function in the K8s data plane.

FIG. 7 schematically shows an example of unreachable worker node in K8s container platform according to an embodiment of the present disclosure.

In this embodiment, the workload-2 (Pod-2) is consuming the long-lived TCP traffics. The worknode-2 becomes unreachable. The CNI plugin may take X time to detect the failure. The value of X may depend on the implementation of the CNI plugin. In the duration of X time, all traffics to workload-2 are lost silently. The connection becomes a blackhole to client.

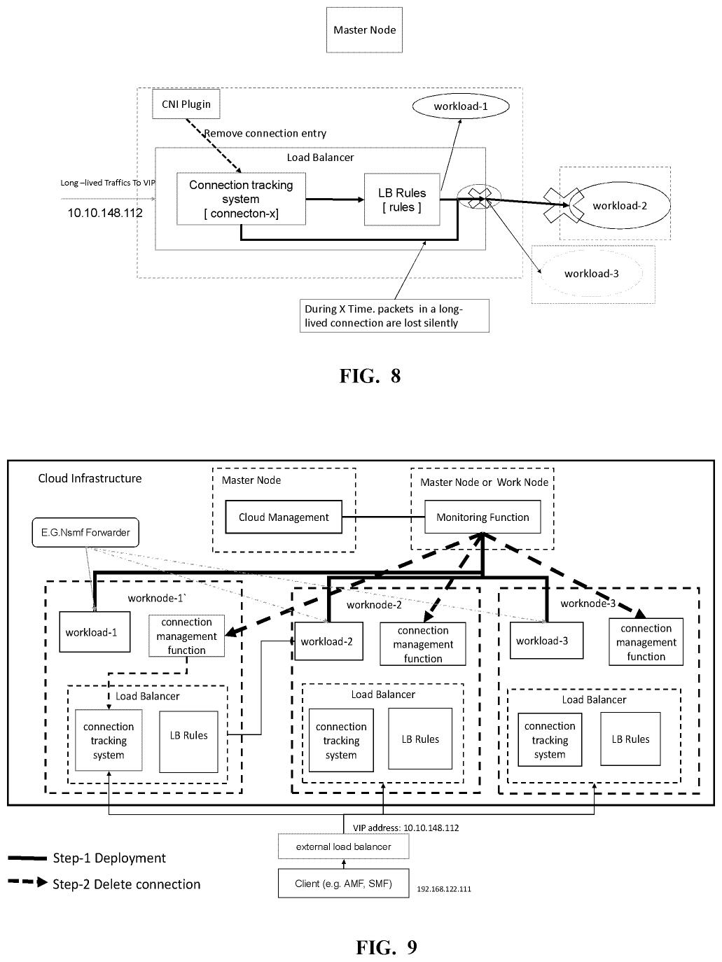

FIG. 8 schematically shows an example of a blackhole connection before reset according to an embodiment of the present disclosure.

After X time the CNI Plugin detects the failure of worknode-2 and deletes all connections related to worknode-2.

For new incoming TCP packets in the same connection, because the connection tracking system in worknode-1 can't get any connection record related to worknode-2, the load balancer distributes the new incoming TCP packets to a new workload and the new workload resets the connection to client.

It may take at least X time to reset a connection. If the CNI plugin can't fast enough to delete the long-lived connection, the connection becomes a “blackhole” to client.

In the 5GC, the TCP long lived connection is used in SBI interface. There is no heartbeat or circuit break mechanism defined in the SBI interfaces. So 5GC won't get a notification of a faulty connection.

If a connection is broken for several minutes, it is not acceptable for a telecommunication product.

In some cloud environment such as public cloud as Amazon Web Services (AWS) and Google, only 99.9% availability is ensured for a worker node (host, VM). The failure frequency can be 175 per year given the node recovery time is 3 minutes. So the service impact time can be 175*3 minutes˜=8 hours per year for the failed link. This will make telecommunication product impossible to achieve 99.999% availability. Therefore an improved solution for connection management may be desirable.

In an embodiment, the improved solution introduces a mechanism to fast fail a fat pipe of an interface (such as 5GC SBI interfaces (which are based on long-lived connections)) for example when a node (host or VM) becomes down by accident.

In an embodiment, the improved solution provides a connection management function to fast delete the connection from connection tracking system.

In an embodiment, the improved solution introduces at least one monitoring function entity and at least one connection management function. The monitoring function entity can fast detect faulty pods and/or unreachable worker nodes and/or unreachable workloads, ignoring the specific cloud platform. The monitoring function entity can tell the connection management function entity to remove “blackhole” connections when a worker node or a pod or a workload becomes unreachable. Then, the client can switch requests to a new workload.

FIG. 9 schematically shows an example of cloud infrastructure according to an embodiment of the present disclosure.

The cloud infrastructure may comprises a master node which may contain a cloud management function.

The monitoring function may be deployed on a cloud node such as worker node or master node. The monitoring function is responsible for monitoring the status of workloads (such as “nsmf forwarder” in 5GC) for example through heartbeat messages and tell the connection management function to delete connection record related to the faulty workload from the connection tracking system when the workload becomes unreachable.

Connection management function may provide an interface to remove all related connection entries from connection tracking system according to a request from the monitoring function. The connection management function may be deployed on a worker node.

The connection tracking system may store information about the state of a connection. For example, the information about the state of a connection may comprise the source and destination IP addresses, port number pairs, protocol types, etc. The connection tracking system may be deployed in a load balancer or cooperate with a load balancer.

The connection tracking system may create a connection record when passing the first packet of a connection to LB rules which will select a workload. With connection tracking, the load balancer only needs to perform workload selection once for a connection. Connection tracking system can bypass the LB rules and forwards the subsequent packets of the connection to previously selected workload directly.

For example, a worker node may comprise one or more workloads, a connection management function, a load balancer, and a connection tracking system.

Step-1. After deployment, the workloads, like Nsmf forwarder, actively connect to the monitoring function and send heartbeat messages to the monitoring function at a predetermined period.

The monitoring function may determine a workload as out of service in few lost heartbeat packets. The loss of heartbeat messages may be caused due to various reasons such as application fault or node problem.

Step-2. The monitoring function confirms that a workload is out of service and sends requests to at least one (or all) alive connection management function on worker nodes to delete related connection records from the worker node's connection tracking system.

Finally, for a previous established connection to the faulty workload, new incoming packet is redistributed to a new workload by the internal load balancer and reset by the new selected workload. Therefore, the client can switch to new workload through sending a new connection request.

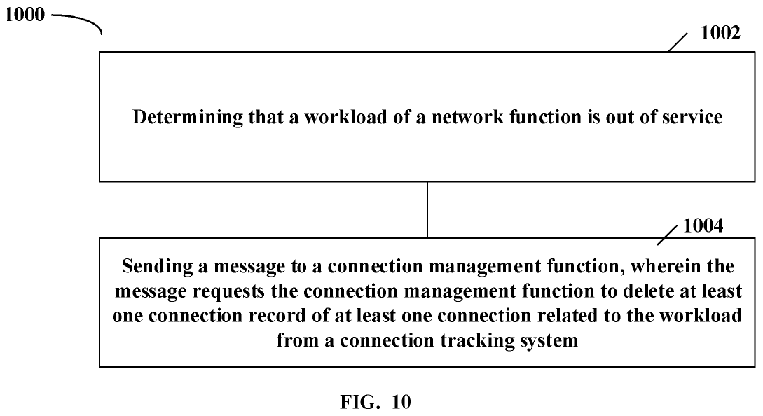

FIG. 10 shows a flowchart of a method according to an embodiment of the present disclosure, which may be performed by an apparatus implemented in or at or as a monitoring function or communicatively coupled to the monitoring function. As such, the apparatus may provide means or modules for accomplishing various parts of the method 1000 as well as means or modules for accomplishing other processes in conjunction with other components.

At block 1002, the monitoring function may determine that a workload of a network function is out of service. The monitoring function may be an independent function or combined with any other suitable function. The monitoring function may be deployed in any suitable network node in a communication network. For example, the monitoring function may be deployed in a work node or a master node.

A workload may be a specific application, service, capability or a specific amount of work that can be run on a cloud resource. In an embodiment, the workload is deployed on a cloud node.

The network function may be any suitable network function and the present disclosure has no limit on it.

In an embodiment, the network function may comprise a network function of a 3rd Generation Partnership Project (3GPP) fifth generation system.

In an embodiment, the network function of the 3GPP fifth generation system comprises at least one of Session Management Function (SMF), Access and mobility Function (AMF), Authentication Service Function (AUSF), Unified Data Management (UDM), Policy Control Function (PCF), Application Function (AF), Network Exposure Function (NEF), User plane Function (UPF), Network Repository Function (NRF), service communication proxy (SCP), network data analytics function (NWDAF), Network Slice Selection Function (NSSF), Network Slice-Specific Authentication and Authorization Function (NSSAAF), or Network Slice Admission Control Function (NSACF).

The monitoring function may determine that a workload of a network function is out of service in various ways. For example, the monitoring function may detect that a workload of a network function is out of service. The monitoring function may receive a notification that a workload of a network function is out of service from another network node.

At block 1004, the monitoring function may send a message to a connection management function. The message requests the connection management function to delete at least one connection record of at least one connection related to the workload from a connection tracking system. The message may comprise any suitable information which can be used to recognize the at least one connection record. For example, if the monitoring function knows which connection record(s) is related to the workload, the message may comprise information about the at least one connection record. In another example, the message may comprise an identity (such as IP address) of the workload. The connection management function and/or the connection tracking system may recognize the at least one connection record based on the identity of the workload.

The connection management function may be an independent function or combined with any other suitable function. The connection management function may be deployed in any suitable network node in a communication network. For example, the connection management function may be deployed in a worker node.

The connection tracking system may be an independent function or combined with any other suitable function. The connection tracking system may be deployed in any suitable network node in a communication network. For example, the connection tracking system may be deployed in a worker node. Alternatively the connection tracking system may be deployed in a LB.

The connection tracking system may create a connection record when passing the first packet of a connection to LB rules which will select a workload. The LB only needs to perform workload selection once for a connection. Connection tracking system can bypass the LB rules and forwards the subsequent packets of the connection to previously selected workload directly.

The connection tracking system may use any suitable packet filtering policies to recognize a connection. For example, The connection tracking system may recognize a connection based on packet header information such as source IP address and port number, destination IP address and port number, and the protocol in use in the data payload.

In an embodiment, a load balancer is responsible for forwarding initial traffic (e.g., the first packet) of a connection from a consumer of the network function to a selected workload of the network function. The connection tracking system is responsible for recording a path of the initial traffic to the selected workload. Subsequent traffic of the connection from the consumer of the network function is forwarded to the selected workload according to the path of the initial traffic.

In an embodiment, a connection record in the connection tracking system may comprise a 5 tuple record or entry, such as source IP address and port number, destination IP address and port number, and the protocol in use in the data payload. In other embodiments, a connection record in the connection tracking system may comprise any suitable information which can be used to determine a connection. For example, the connection record may comprise at least one of source address, destination address, source port number, destination port number, layer-4 protocol information, layer-3 protocol information, etc. For example layer-4 protocol may comprise TCP, UDP, SCTP, etc. Layer-3 protocol may comprise IPv4 or IPv6.

The connection may comprise any suitable protocol connection. In an embodiment, the at least one connection may comprise a layer 4 protocol connection.

In an embodiment, the layer 4 protocol connection comprises at least one of a Transmission Control Protocol (TCP) connection, a User Datagram Protocol (UDP) connection, or a Stream Control Transmission Protocol (SCTP) connection. For example, the UDP may be used in PFCP (Packet Forwarding Control Protocol) protocol between SMF and UPF. SCTP may be used for AMF. TCP may be used for all NFs in 5GC.

In an embodiment, the layer 4 protocol connection comprises a long lived layer 4 protocol connection. A long lived connection may be a connection that lasts for a long time.

In an embodiment, the network function comprises two or more workloads.

In an embodiment, the monitoring function may send the message to all connection management functions in the network respectively. Each connection management function may delete at least one connection record of at least one connection related to the workload from a connection tracking system managed by each connection management function.

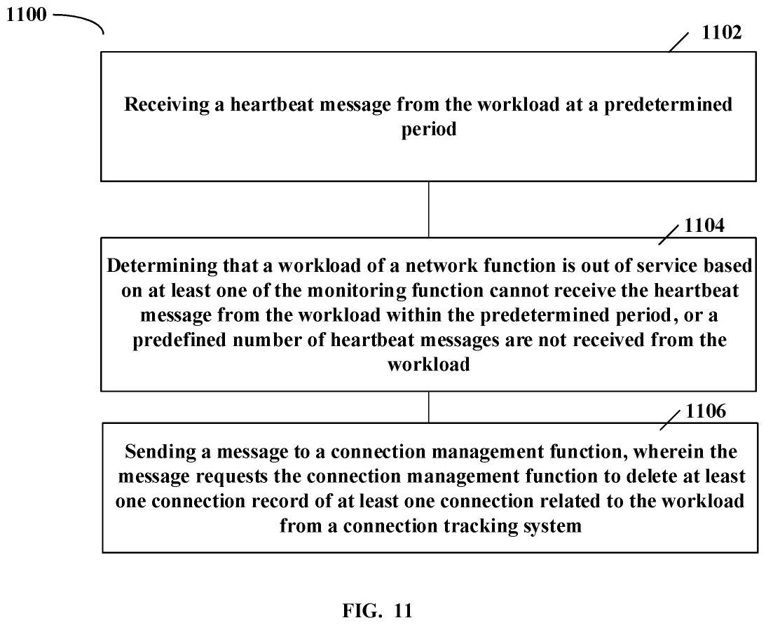

FIG. 11 shows a flowchart of a method according to another embodiment of the present disclosure, which may be performed by an apparatus implemented in or at or as a monitoring function or communicatively coupled to the monitoring function. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the monitoring function may receive a heartbeat message from the workload at a predetermined period. The predetermined period may be any suitable period for example configured by an operator. The heartbeat message can be implemented by HTTP method, TCP method or running any command remotely to detect the health of the workload.

At block 1104, the monitoring function may determine that a workload of a network function is out of service.

In an embodiment, the workload is determined as out of service based on at least one of the monitoring function cannot receive the heartbeat message from the workload within the predetermined period or a predefined number of heartbeat messages are not received from the workload. The predefined number of heartbeat messages may be any suitable number for example configured by an operator.

At block 1106, the monitoring function may send a message to a connection management function. Block 1106 is same as block 1004 of FIG. 10.

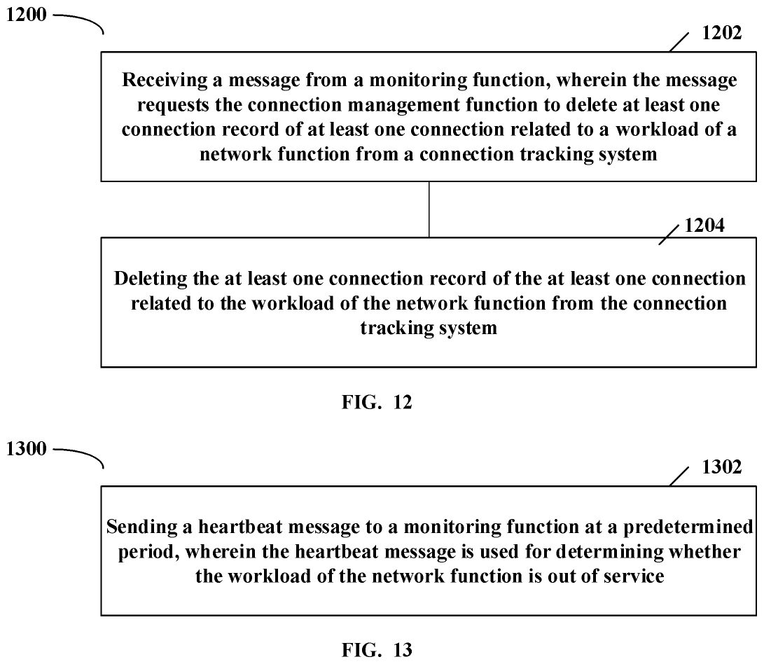

FIG. 12 shows a flowchart of a method according to another embodiment of the present disclosure, which may be performed by an apparatus implemented in or at or as a connection management function or communicatively coupled to the connection management function. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the connection management function may receive a message from a monitoring function. The message requests the connection management function to delete at least one connection record of at least one connection related to a workload of a network function from a connection tracking system. For example, the monitoring function may send the message to the connection management function at block 1004 of FIG. 10 or block 1106 of FIG. 11, and then the connection management function may receive the message from the monitoring function.

At block 1204, the connection management function may delete the at least one connection record of the at least one connection related to the workload of the network function from the connection tracking system. For example, the connection management function may send a command to the connection tracking system to delete the at least one connection record of the at least one connection related to the workload of the network function. The command may comprise information of the at least one connection record or the identity of the workload.

In an embodiment, each connection management function in the communication system may perform the block 1202 and 1204.

In an embodiment, the workload is deployed on a cloud node.

In an embodiment, the network function comprises a network function of a 3rd Generation Partnership Project (3GPP) fifth generation system.

In an embodiment, the network function of the 3GPP fifth generation system comprises at least one of Session Management Function (SMF), Access and mobility Function (AMF), Authentication Service Function (AUSF), Unified Data Management (UDM), Policy Control Function (PCF), Application Function (AF), Network Exposure Function (NEF), User plane Function (UPF), Network Repository Function (NRF), service communication proxy (SCP), network data analytics function (NWDAF), Network Slice Selection Function (NSSF), Network Slice-Specific Authentication and Authorization Function (NSSAAF), or Network Slice Admission Control Function (NSACF).

In an embodiment, the at least one connection comprises a layer 4 protocol connection.

In an embodiment, the layer 4 protocol connection comprises at least one of a Transmission Control Protocol (TCP) connection, a User Datagram Protocol (UDP) connection, or a Stream Control Transmission Protocol (SCTP) connection.

In an embodiment, the layer 4 protocol connection comprises a long lived layer 4 protocol connection.

In an embodiment, the network function comprises two or more workloads.

In an embodiment, a load balancer is responsible for forwarding initial traffic of a connection from a consumer of the network function to a selected workload of the network function, the connection tracking system is responsible for recording a path of the initial traffic to the selected workload, and subsequent traffic of the connection from the consumer of the network function is forwarded to the selected workload according to the path of the initial traffic.

In an embodiment, a connection record in the connection tracking system comprises at least one of source address, destination address, source port number, destination port number, layer-4 protocol information, or layer-3 protocol information.

In an embodiment, a connection record in the connection tracking system comprises a 5 tuple record or entry.

FIG. 13 shows a flowchart of a method according to another embodiment of the present disclosure, which may be performed by an apparatus implemented in or at or as a workload of a network function or communicatively coupled to the workload of a network function. As such, the apparatus may provide means or modules for accomplishing various parts of the method 1300 as well as means or modules for accomplishing other processes in conjunction with other components. For some parts which have been described in the above embodiments, the description thereof is omitted here for brevity.

At block 1302, the workload of a network function may send a heartbeat message to a monitoring function at a predetermined period. The heartbeat message is used for determining whether the workload of the network function is out of service.

In an embodiment, the workload is determined as out of service based on at least one of the monitoring function cannot receive the heartbeat message from the workload within the predetermined period, or a predefined number of heartbeat messages are not received from the workload.

In an embodiment, the workload is deployed on a cloud node.

In an embodiment, the network function comprises a network function of a 3rd Generation Partnership Project (3GPP) fifth generation system.

In an embodiment, the network function of the 3GPP fifth generation system comprises at least one of Session Management Function (SMF), Access and mobility Function (AMF), Authentication Service Function (AUSF), Unified Data Management (UDM), Policy Control Function (PCF), Application Function (AF), Network Exposure Function (NEF), User plane Function (UPF), Network Repository Function (NRF), service communication proxy (SCP), network data analytics function (NWDAF), Network Slice Selection Function (NSSF), Network Slice-Specific Authentication and Authorization Function (NSSAAF), or Network Slice Admission Control Function (NSACF).

In an embodiment, a connection served by the workload comprises a layer 4 protocol connection.

In an embodiment, the layer 4 protocol connection comprises at least one of a Transmission Control Protocol (TCP) connection, a User Datagram Protocol (UDP) connection, or a Stream Control Transmission Protocol (SCTP) connection.

In an embodiment, the layer 4 protocol connection comprises a long lived layer 4 protocol connection.

In an embodiment, the network function comprises two or more workloads.

In an embodiment, a load balancer is responsible for forwarding initial traffic of a connection from a consumer of the network function to a selected workload of the network function, a connection tracking system is responsible for recording a path of the initial traffic to the selected workload, and subsequent traffic of the connection from the consumer of the network function is forwarded to the selected workload according to the path of the initial traffic.

In an embodiment, a connection record in the connection tracking system comprises at least one of source address, destination address, source port number, destination port number, layer-4 protocol information, or layer-3 protocol information.

In an embodiment, a connection record in the connection tracking system comprises a 5 tuple record or entry.

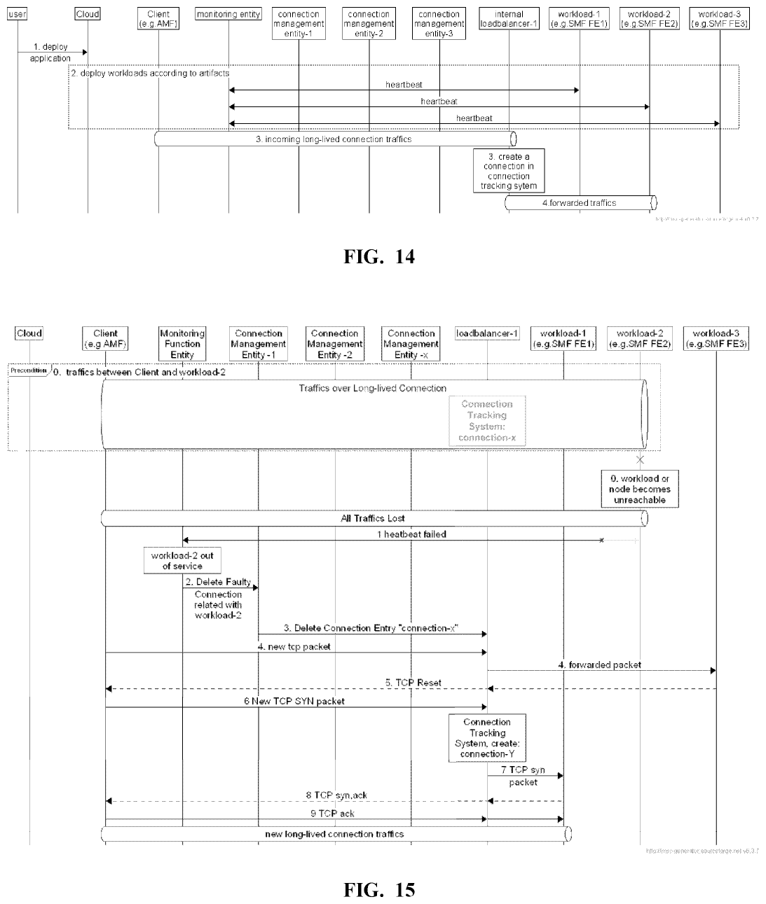

FIG. 14 shows a flowchart of network function deployment according to an embodiment of the present disclosure.

At step 1, a user deploys a network function (e.g., SMF) on a cloud platform, e.g. using a deployment artifact, helm chart, etc. The cloud platform may be any suitable cloud platform and the present disclosure has no limit on it. In an embodiment, the cloud may be implemented through K8s.

At step 2, the cloud deploys the workloads according to the deployment artifact. For example, the cloud deploys three workloads, e.g., SMF FE1, SMF FE2, SMF FE3. The workloads actively connect to the monitoring function entity and send heartbeat messages to the monitoring function entity at a predefined period.

At step 3, a long lived connection request from client (e.g., AMF) may be handled on internal load balancer-1, which creates a connection record in a connection tracking system.

At step 4, the load balancer selects workload-2 as traffics handler and forwards traffics to it.

FIG. 15 shows a flowchart of traffics handling during workload failover according to an embodiment of the present disclosure.

The monitoring function entity, connection management function entities and workloads are deployed for example according to the method of FIG. 14. There has an established connection record “connection-X” in the connection tracking system on load balancer-1.

At step 0, because of fault, the workload-2 or worknode-2 becomes unreachable and all ongoing traffics over long-lived TCP connection between the client (e.g., AMF) and workload-2 are lost.

At step 1, the heartbeat message between workload-2 and the monitoring function entity is timeout for few times. The monitoring function entity sets the workload-2 as out of service.

At step 2, the monitoring function entity requests a connection management entity-1 to delete the connection record(s) related with workload-2. In other embodiments, the monitoring function entity requests all connection management entities to delete the connection record(s) related with workload-2.

At step 3, the connection management entity-1 deletes the connection “connection-X” from the connection tracking system.

At step 4, the client retransmits a new TCP packet and the load balancer-1 selects a new workload (e.g., workload-3) to handle with the retransmitted TCP packet.

At step 5, workload-3 resets the packet to ask for a new connection request, because it doesn't owe the connection before.

At step 6, the client sends a new TCP SYN packet to an VIP address of SMF. The load balancer-1 tracks this new connection with a new connection record “connection-Y” in the connection tracking system.

At step 7, load balancer-1 selects a new workload (e.g., workload-1) to handle with TCP SYN request.

At step 8, workload-1 accepts the request and acknowledge the connection to client.

At step 9, the client sends TCP ACK to acknowledge the connection finally.

Finally, the new long-lived TCP traffics are setup between workload-1 and client in few TCP packets interaction.

Note that even though the example above using TCP, the same mechanism can be applied for fat pipe using UDP or SCTP. The connection tracking system can keep UDP/SCTP connection records.

According to various embodiments, it introduces a mechanism to fail a fat pipe (such as HTTP TCP long live connection) fast in a network (such as the cloud native 5GC) when a workload or a cloud node where a NF (such as the 5G NF) stays become unreachable. Therefore, the client can switch a further request to available fat pipes which may enhance the robustness for interfaces (such as 5GC SBI interface services) and increase the request successful rates.

Embodiments herein afford many advantages, of which a non-exhaustive list of examples follows. In some embodiments herein, it proposed a server side solution that does not impact on the client behavior or require client changes. For example, the client implementation in the 3GPP standard does not specify monitoring for the HTTP over long live TCP connection. The client behaviors may be different. This is super important in a multiple vendor environment which is a typical deployment scenario for a communication network since it is hard to ask other vendor's clients to change. Some embodiments herein can fast delete hung connections. All related connections can be deleted as soon as a node or workload becomes unreachable. Some embodiments herein can enable cloud agonistic. The proposed solution can offer a fast detect solution without depending on cloud platform and special capabilities of a CNI plugin. Some CNI might offer fast connection deleting in the connection track deleting. If a vendor product prefers it, then the CNI plugin is locked in. Sometimes it is hard to optimize the node failure detection behavior to optimize the connection tracking system fast deletion when the control plane can be owned by a cloud provider such as CaaS provider, HCP (Hyperscale Cloud Platform) provider, Openshift private cloud providers. The embodiments herein are not limited to the features and advantages mentioned above. A person skilled in the art will recognize additional features and advantages upon reading the following detailed description.

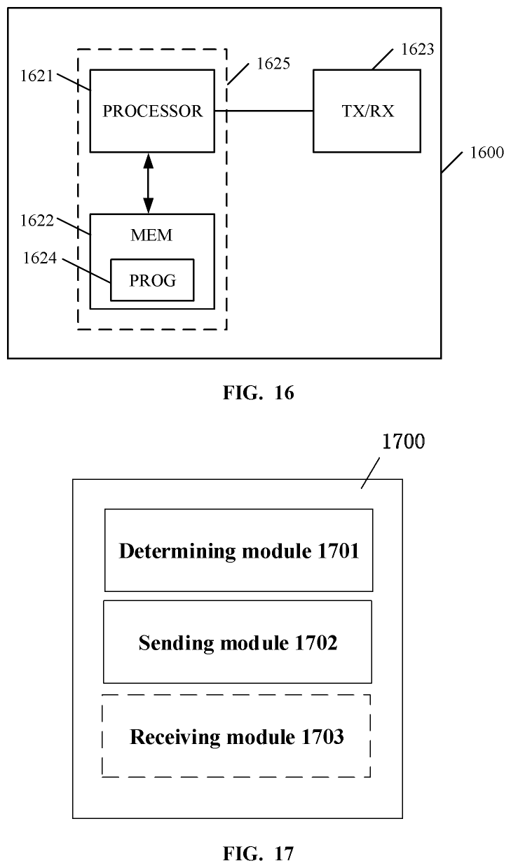

FIG. 16 is a block diagram showing an apparatus suitable for practicing some embodiments of the disclosure. For example, any one of the monitoring function, the connection management function or the workload described above may be implemented as or through the apparatus 1600.

The apparatus 1600 comprises at least one processor 1621, such as a digital processor (DP), and at least one memory (MEM) 1622 coupled to the processor 1621. The apparatus 1620 may further comprise a transmitter TX and receiver RX 1623 coupled to the processor 1621. The MEM 1622 stores a program (PROG) 1624. The PROG 1624 may include instructions that, when executed on the associated processor 1621, enable the apparatus 1620 to operate in accordance with the embodiments of the present disclosure. A combination of the at least one processor 1621 and the at least one MEM 1622 may form processing means 1625 adapted to implement various embodiments of the present disclosure.

Various embodiments of the present disclosure may be implemented by computer program executable by one or more of the processor 1621, software, firmware, hardware or in a combination thereof.

The MEM 1622 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1621 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the monitoring function, the memory 1622 contains instructions executable by the processor 1621, whereby the monitoring function operates according to any step of any of the methods related to the monitoring function as described above.

In an embodiment where the apparatus is implemented as or at the connection management function, the memory 1622 contains instructions executable by the processor 1621, whereby the connection management function operates according to any step of the methods related to the connection management function as described above.

In an embodiment where the apparatus is implemented as or at the workload, the memory 1622 contains instructions executable by the processor 1621, whereby the workload operates according to any step of the methods related to the workload as described above.

FIG. 17 is a block diagram showing a monitoring function according to an embodiment of the disclosure. As shown, the monitoring function 1700 comprises a determining module 1701 configured to determining that a workload of a network function is out of service. The monitoring function 1700 further comprises a sending module 1702 configured to send a message to a connection management function. The message requests the connection management function to delete at least one connection record of at least one connection related to the workload from a connection tracking system.

In an embodiment, the monitoring function 1700 further comprises a receiving module 1703 configured to receive a heartbeat message from the workload at a predetermined period. The workload is determined as out of service based on at least one of the monitoring function cannot receive the heartbeat message from the workload within the predetermined period or a predefined number of heartbeat messages are not received from the workload.

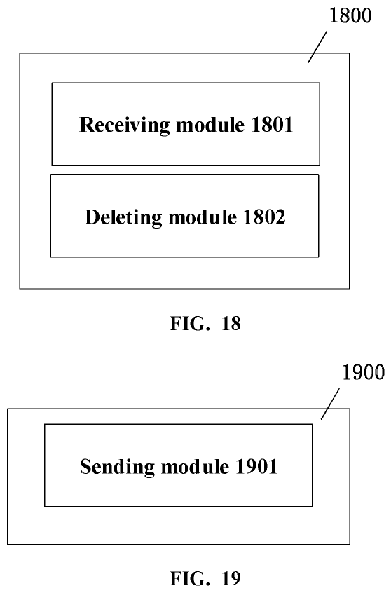

FIG. 18 is a block diagram showing a connection management function according to an embodiment of the disclosure. As shown, the connection management function 1800 comprises a receiving module 1801 configured to receive a message from a monitoring function. The message requests the connection management function to delete at least one connection record of at least one connection related to a workload of a network function from a connection tracking system. The connection management function 1800 further comprises a deleting module 1802 configured to deleting the at least one connection record of the at least one connection related to the workload of the network function from the connection tracking system.

FIG. 19 is a block diagram showing a workload of a network function according to an embodiment of the disclosure. As shown, the workload 1900 comprises a sending module 1901 configured to send a heartbeat message to a monitoring function at a predetermined period. The heartbeat message is used for determining whether the workload of the network function is out of service.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the monitoring function, the connection management function or the workload may not need a fixed processor or memory, any computing resource and storage resource may be arranged from the monitoring function, the connection management function or the workload in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a monitoring function, comprising:
determining that a workload of a network function is out of service; and
sending a message to a connection management function, the message requesting the connection management function to delete at least one connection record of at least one connection related to the workload from a connection tracking system.

2. The method according to claim 1, further comprising:
receiving a heartbeat message from the workload at a predetermined period, wherein the workload is determined as out of service based on at least one of:
the monitoring function cannot receive the heartbeat message from the workload within the predetermined period; or
a predefined number of heartbeat messages are not received from the workload.

3. The method according to claim 1, wherein the workload is deployed on a cloud node.

4. The method according to claim 1, wherein the network function comprises a network function of a 3rd Generation Partnership Project (3GPP) fifth generation system.

5. The method according to claim 4, wherein the network function of the 3GPP fifth generation system comprises at least one of:
Session Management Function (SMF);
Access and mobility Function (AMF);
Authentication Service Function (AUSF);
Unified Data Management (UDM);
Policy Control Function (PCF);
Application Function (AF);
Network Exposure Function (NEF);
User plane Function (UPF);
Network Repository Function (NRF);
service communication proxy (SCP);
network data analytics function (NWDAF);
Network Slice Selection Function (NSSF);
Network Slice-Specific Authentication and Authorization Function (NSSAAF); or
Network Slice Admission Control Function (NSACF).

6. The method according to claim 1, wherein the at least one connection comprises a layer 4 protocol connection.

7.-9. (canceled)

10. The method according to claim 1, wherein a load balancer is responsible for forwarding initial traffic of a connection from a consumer of the network function to a selected workload of the network function, the connection tracking system is responsible for recording a path of the initial traffic to the selected workload, and subsequent traffic of the connection from the consumer of the network function is forwarded to the selected workload according to the path of the initial traffic.

11. The method according to claim 1, wherein a connection record in the connection tracking system comprises at least one of source address, destination address, source port number, destination port number, layer-4 protocol information, or layer-3 protocol information.

12. The method according to claim 1, wherein a connection record in the connection tracking system comprises a 5 tuple record or entry.

13. A method performed by a connection management function, the method comprising:
receiving a message from a monitoring function, wherein the message requests requesting the connection management function to delete at least one connection record of at least one connection related to a workload of a network function from a connection tracking system; and
deleting the at least one connection record of the at least one connection related to the workload of the network function from the connection tracking system.

14. The method according to claim 13, wherein the workload is deployed on a cloud node.

15. (canceled)

16. (canceled)

17. The method according to claim 13, wherein the at least one connection comprises a layer 4 protocol connection.

18. (canceled)

19. (canceled)

20. The method according to claim 13, wherein the network function comprises two or more workloads.

21. The method according to claim 13, wherein a load balancer is responsible for forwarding initial traffic of a connection from a consumer of the network function to a selected workload of the network function, the connection tracking system is responsible for recording a path of the initial traffic to the selected workload, and subsequent traffic of the connection from the consumer of the network function is forwarded to the selected workload according to the path of the initial traffic.

22. (canceled)

23. (canceled)

24. A method performed by a workload of a network function, the method comprising:
sending a heartbeat message to a monitoring function at a predetermined period, the heartbeat message being used for determining whether the workload of the network function is out of service.

25. The method according to claim 24, wherein the workload is determined as out of service based on at least one of:
the monitoring function cannot receive the heartbeat message from the workload within the predetermined period; or
a predefined number of heartbeat messages are not received from the workload.

26. The method according to claim 24, wherein the workload is deployed on a cloud node.

27.-31. (canceled)

32. The method according to claim 24, wherein the network function comprises two or more workloads.

33. The method according to claim 24, wherein a load balancer is responsible for forwarding initial traffic of a connection from a consumer of the network function to a selected workload of the network function, a connection tracking system is responsible for recording a path of the initial traffic to the selected workload, and subsequent traffic of the connection from the consumer of the network function is forwarded to the selected workload according to the path of the initial traffic.

34. (canceled)

35. (canceled)

36. A monitoring function, comprising:
a processor; and
a memory coupled to the processor, said memory containing instructions executable by said processor, whereby said monitoring function is operative to:
determine that a workload of a network function is out of service; and
send a message to a connection management function, the message requesting the connection management function to delete at least one connection record of at least one connection related to the workload from a connection tracking system.

37.-43. (canceled)
